(19) United States
(12) Patent Application Publication
(10) Pub. No.: US 2025/0348124 A1
(43) Pub. Date: Nov. 13, 2025

(54) DEVICE PROXIMITY DETECTION WITH REDUCED LATENCY

(71) Applicant: Apple Inc., Cupertino, CA (US)

(72) Inventor: Subash Marri Sridhar, Hayward, CA (US)

(73) Assignee: Apple Inc., Cupertino, CA (US)

(21) Appl. No.: 19/081,900

(22) Filed: Mar. 17, 2025

Related U.S. Application Data
(60) Provisional application No. 63/646,423, filed on May 13, 2024.

(51) Int. Cl. G06F 1/3206

(52) U.S. Cl. CPC G06F 1/3206

(57) ABSTRACT

A method may include receiving first data from an external device. The first data may include information identifying the external device and a status of the external device. The first data may be received while the application processor is in a lower power mode. The method may include transmitting the first data to the auxiliary processor, the auxiliary processor powered on more often than the application processor. The method may include identifying the first data as being received from the external device. The method may include storing the first data in a buffer for subsequent access by the application processor. In response to receiving a trigger, the method may include exiting, by the application processor, the lower power mode. The method may include processing the first data from the buffer to determine the status of the external device. The method may include generating and displaying a status notification.

### CROSS-REFERENCES TO OTHER APPLICATIONS

This application claims priority to U.S. Provisional Application No. 63/646,423, for “DEVICE PROXIMITY DETECTION WITH REDUCED LATENCY” filed on May 13, 2024, which is herein incorporated by reference in its entirety for all purposes.

### BACKGROUND

Mobile devices such as cellular phones were originally designed to enable voice calls to be made by a user from relatively anywhere. As mobile devices and related technology evolved, so did uses and tasks performed by mobile devices. Technologies such as short messaging service (SMS) allowed mobile devices to send and receive text messages, Wi-Fi circuitry enabled connection to local area networks in homes and businesses, etc. As display and processor technologies have advanced, mobile devices have become common platforms for media playback (e.g., video and audio). Other protocols and technologies were also developed in order to enhance these new functionalities. For example, instead of headphones that plug into the mobile device, headphones may now be connected to the mobile device wirelessly. The technology used to connect headphones to the mobile device may also be used to connect the mobile device to other external devices. The external devices can be used in tasks such as video playback, location services (e.g., finding a connected device), and other tasks. Thus, a user may use both a mobile device and an external device in order to perform desired tasks (e.g., audio playback).

External devices may be used to perform peripheral functions with a user device. When a user wishes to connect to an external device with a user device, a status of the external device may be displayed on the user device. However, there may be latency issues in generating a display of the status on the user device. Thus, there is a need to decrease latency in generating a status display to improve the user's experience.

### BRIEF SUMMARY

A method may be performed by an electronic device including wireless communication circuitry. The method may include receiving, by the wireless circuitry, first data from an external device, the first data may include information identifying the external device and a status of the external device, where the first data is received while the application processor is in a lower power mode. The method may include transmitting, by the wireless circuitry, the first data to the auxiliary processor, where the auxiliary processor is powered on more often than the application processor. The method may include identifying, by the auxiliary processor of the electronic device, the first data as being received from the external device. The method may include responsive to identifying the first data as received from the external device, storing the first data in a buffer for subsequent access by the application processor. In response to receiving a trigger: the method may include exiting, by the application processor, the lower power mode. The method may include processing, by the application processor, the first data from the buffer to determine the status of the external device. The method may include generating, by the application processor, a status notification based on the status of the external device; and displaying the status notification.

In some embodiments, the first data from the external device may indicate a data type, and the electronic device stores the first data based on the data type. After exiting the low power mode for the application processor, the method may include receiving, by the wireless circuitry, second data from a second external device, the second data including information identifying the second external device. The method may include determining, by the wireless circuitry, that the second external device is not paired with the electronic device. The method may include generating, by the application processor, a share request, where, in response to a user input corresponding to the share request, the electronic device may pair with the second external device. The method may include displaying the share request. The share request may be generated based on a user input received by the external device.

In some embodiments, the method may include determining, by the application processor, a signal strength associated with the external device based at least in part on the data received from the external device. The method may include determining, by the application processor, whether or not the external device is within a proximity threshold of the electronic device based at least in part on the signal strength. In response to determining that the external device is outside of the proximity threshold, the method may include causing the data to be deleted from the buffer. In response to determining that the external device is within the proximity threshold, the method further may include generating, by the application processor, the status notification.

A computing device may include one or more processors and a memory storing instructions that, when executed by the one or more processors, cause the system to perform operations. According to the instructions, the device may receive, by the wireless circuitry, first data from an external device, the first data may include information identifying the external device and a status of the external device, where the first data is received while the application processor is in a lower power mode. The device may transmit, by the wireless circuitry, the first data to the auxiliary processor, where the auxiliary processor is powered on more often than the application processor. The device may identify, by the auxiliary processor of the electronic device, the first data as being received from the external device. Responsive to identifying the first data as received from the external device, the device may store the first data in a buffer for subsequent access by the application processor. In response to receiving a trigger, the device may exit, by the application processor, the lower power mode. The device may process, by the application processor, the first data from the buffer to determine the status of the external device. The device may generate, by the application processor, a status notification based on the status of the external device. The device may display the status notification.

In some embodiments, the instructions may cause the computing device to determine, by the auxiliary processor, positioning data from a global positioning module of the electronic device. The computing device may store, by the auxiliary processor, the positioning data in the buffer such that the positioning data is associated with the first data. The external device may include an audio playback device. The buffer may include a circular buffer. The first data may be included in a Bluetooth advertisement. Only a portion of the data received by the wireless circuitry may be stored in the buffer. The application processor may generate a pairing request based on the data received from the external device. The buffer may be configured to be accessible by the application processor while in a higher power mode.

A non-transitory computer-readable medium may include instructions that, when executed by one or more processors, cause the one or more processors to perform operations. The operations may include receiving, by the wireless circuitry, first data from an external device, the first data may include information identifying the external device and a status of the external device, where the first data is received while the application processor is in a lower power mode. The operations may include transmitting, by the wireless circuitry, the first data to the auxiliary processor, where the auxiliary processor is powered on more often than the application processor. The operations may include identifying, by the auxiliary processor of the electronic device, the first data as being received from the external device. The operations may include responsive to identifying the first data as received from the external device, storing the first data in a buffer for subsequent access by the application processor. In response to receiving a trigger: the operations may include exiting, by the application processor, the lower power mode. The operations may include processing, by the application processor, the first data from the buffer to determine the status of the external device. The operations may include generating, by the application processor, a status notification based on the status of the external device; and displaying the status notification.

In some embodiments, the operations may include determining, by the auxiliary processor, a signal strength associated with the external device based at least in part on the data received from the external device. The operations may include determining, by the auxiliary processor, whether the external device is within a certain proximity of the electronic device, based at least in part on the signal strength. The operations may include generating, by the auxiliary processor, the trigger. The operations may include determining whether the external device is within a certain proximity of the electronic device is based at least in part on location data of the electronic device and/or movement data of the electronic device.

The operations may include receiving, by the wireless circuitry, third data from the external device. The operations may include identifying, by the auxiliary processor of the electronic device, the third data as being received from the external device, and being received at a later time than the first data. The operations may include storing the first data in a second memory and removing the first data from the buffer. The operations may include storing the third data in the buffer for subsequent access by the application processor. The buffer may include a data associated with a plurality of external devices, the operations may include determining, by the application processor, a nearest external device of the plurality of external devices based at least on part with the data associated with the plurality of external devices. The operations may include generating, by the application processor, the status notification based on the status of the nearest external device. The external device may include earbuds.

### BRIEF DESCRIPTION OF THE DRAWINGS

FIG. 1 illustrates a system with an example flow for displaying a device status on a user device, according to certain embodiments.

FIG. 2 illustrates a system and a process for reducing latency in proximity detection of an external device, according to certain embodiments.

FIG. 3 illustrates an external device broadcasting data, according to certain embodiments.

FIG. 4 illustrates a system for receiving and preprocessing data with a single auxiliary processor, according to certain embodiments.

FIG. 5A illustrates a user device displaying a status notification, according to certain embodiments.

FIG. 5B illustrates the user device displaying a pair request, according to certain embodiments.

FIG. 5C illustrates the user device displaying a share request associated with a second external device, according to certain embodiments.

FIG. 6 illustrates a method for displaying status notifications, according to certain embodiments.

FIG. 7 is a block diagram of an example always-on system architecture, which may include a system-on-chip (SoC) in a mobile device.

### DETAILED DESCRIPTION

In order to use the mobile device and the external device together, both the mobile device and the external device may need to be associated with one another (e.g., paired), have adequate power or battery level, etc. The mobile device may include a display providing a convenient method to convey a status of the mobile device. Some external devices, such as headphones, may not include a display. In order to determine the status of an external device, the external device may transmit data indicating a status of the external device (and/or other information) to the mobile device. The mobile device may then generate a display of some or all of the transmitted data in order to convey the status of the external device to the user. In order to display the status of the external device, however, the mobile device may need to be in an active state, with the display of the mobile device powered on, a processor actively processing the data, and other components of the mobile device performing other tasks—all of which consume energy and take time. If the mobile device is not in an active state, then the mobile device may not begin the process until the mobile device “wakes up.”

Furthermore, the user may only desire information about the external device when the user is using (or about to use) the external device. For example, the user may provide an input to the external device (e.g., opening a lid) that indicates the user desires to use the external device. The mobile device may be in the active state or may enter the active state in response to a user input. The mobile device may then receive the data from the external device and begin to process the data to display the status.

### I. Latency Between Entering Active State and Display of Notification

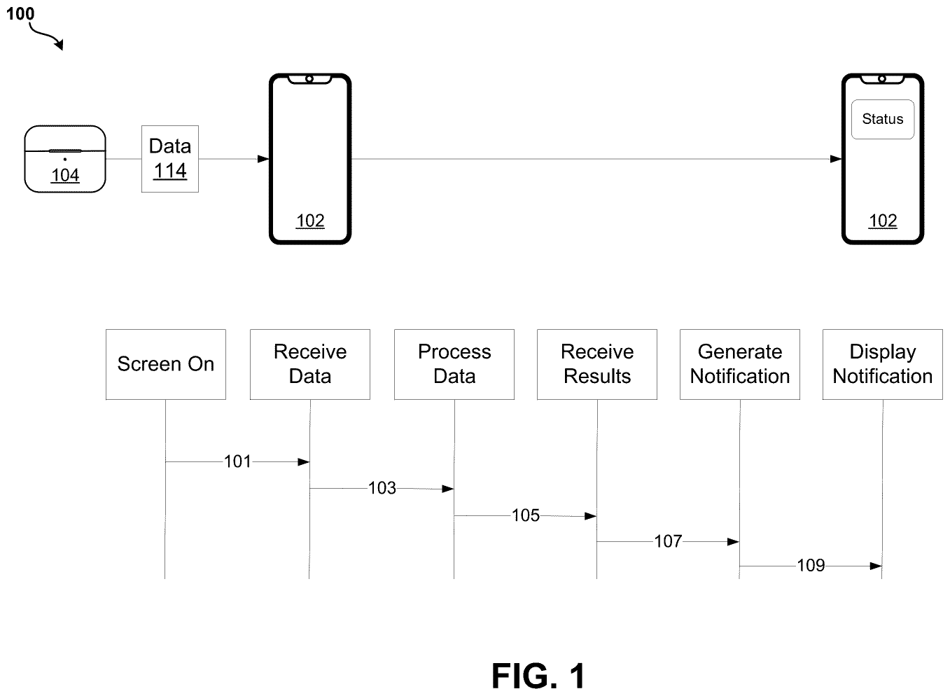

FIG. 1 illustrates a system 100 with an example flow for displaying a device status on a user device 102, according to certain embodiments. The system 100 may include a user device 102 and an external device 104. The user device 102 may be an electronic device such as a mobile phone, smartphone, tablet, laptop, or any other suitable device. The external device 104 may include headphones, video display, mouse, keyboard, or any other suitable type of device. In other words, the external device 104 may be a peripheral device, used in conjunction with the user device 102 to perform a task (e.g., audio playback). In the example shown in FIG. 1, the external device 104 may be earbuds inside a case.

The user device 102 and the external device 104 may communicate with one another via wireless communication protocols such as Wi-Fi, near field communication (NFC), Bluetooth, or other suitable protocols. The external device 104 may broadcast data 114. The data 114 may include information such as a device ID (e.g., identifying the external device), a power level or battery status, a pairing status, and other such information. The external device 104 may broadcast the data 114 at regular intervals (e.g., every ½ second, 1 second, 2 seconds, 5 seconds, etc.). The external device 104 may additionally or alternatively broadcast the data 114 in response to a user input such as opening a lid of the case of the external device 104.

Initially, the user device 102 may not be in an active state. For example, the screen of the user device 102 may not be on. A user may then open the case of the external device 104 (e.g., to use the earbuds within) and/or wake up the user device 102. The screen of the user device 102 turns on, and the user device 102 may enter an active state. At 101, the user device 102 may start looking for the data 114, broadcast by the external device 104. The user device may receive the next broadcast of the data 114. For example, if the external device 104 broadcasts the data 114 every ½ second, then the user device 102 may not receive the data 114 until ½ second after entering the active state. After receiving the data 114, at 103, the user device 102 may provide the data 114 to one or more components of the user device 102 for processing.

Then, at 105, the user device 102 may process the data 114. Processing the data 114 may include determining the device ID, the power level, the pairing status, etc. The processing may also determine a proximity of the user device 102 to the external device 104. Using the results of the processing, at 107, the user device 102 may generate a status notification including information about the external device. The information may include the proximity, the power level, the pairing status, etc. Finally, the user device 102 may display the status notification at 109.

Each of the steps 101-109 may include an associated time to perform each step. A user experience may be based, at least in part, on the total time taken to display the status notification from the time the user device 102 enters the active state. While, in theory, the process outlined above may occur in less than a second, the actual user experience may be different. For example, the user device 102 may be performing other tasks upon entering the active state, taking up memory and/or processing power needed to process the data 114 and display the notification.

Thus, the time between opening the lid of the external device 104 (and/or the user device 102 entering the active state) may be 2 seconds, 5 seconds, 10 seconds, or longer. Therefore, there is a need to process the data 114 to generate the status notification more efficiently to improve the user experience.

Steps 103-109 may occur solely within the user device 102, governed by the circuitry and processing power of the user device 102. While altering the hardware may enable the user device 102 to perform some or all of the steps 103-109 faster, altering the hardware may not be a practical solution. For example, once the user device 102 has been manufactured, altering the hardware included therein may be prohibitively expensive and inconvenient for the user. Thus, time savings (and associated improvement of the user experience) may require other solutions.

### II. Buffering Measured Data by Auxiliary Processor

One solution may be to leverage the regular broadcasts of data by an external device. A user device may receive broadcasts of data from an external device, even when the user device is not in an active state. The data may be received by active or passive wireless circuitry included in the user device. Using an auxiliary processor the user device may preprocess the data received from the external device, to determine whether or not the external device is associated with the user device (e.g., previously paired, etc.), within a proximity threshold of the user device, etc. The data may be stored in a buffer accessible to the auxiliary processor and/or stored elsewhere within the user device.

Upon entering an active state and/or in response to a trigger associated with the external device, an application processor of the user device may access the data from the buffer. The application processor may then use some or all of the data to generate a notification and display the notification on a display of the user device. As the wireless circuitry and AOP are receiving and preprocessing the data while the user device is not in the active state, the user device may begin processing the data upon entering the active state. Put differently, the user device may not need to wait to receive the data after entering the active state, saving time. Furthermore, because the data may be preprocessed, the application processor may have fewer tasks to perform in order to generate and display the status notification, saving even more time.

The time saved may lead to an improved user experience.

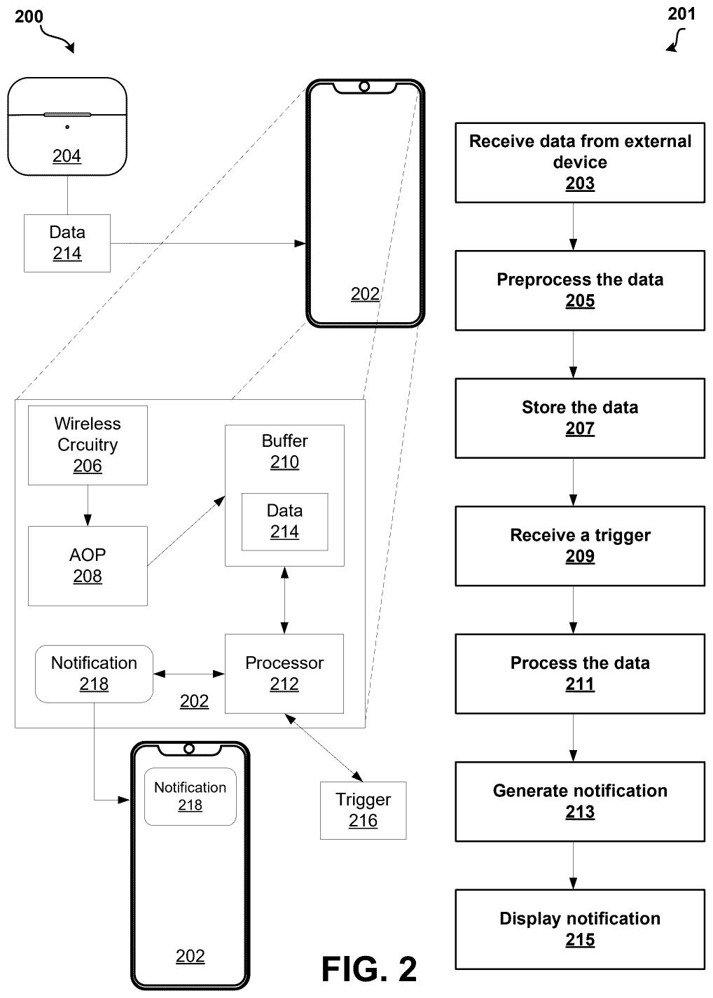

FIG. 2 illustrates a system 200 and a process 201 for reducing latency in proximity detection of an external device 204, according to certain embodiments.

### A. System Overview

The system 200 may include a user device 202 and the external device 204. The user device 202 may include wireless circuitry 206, an AOP 208, a buffer 210, and an application processor 212. The user device 202 may be a cell phone, smartphone, tablet, laptop, wearable device (e.g., a watch, eyewear, etc.) or any other type of electronic device. The external device 204 may be a peripheral device, such as headphones, a video display, a mouse, a keyboard, or any other suitable type of device. In the example shown in FIG. 2, the external device 204 may be earbuds within a case.

The wireless circuitry 206 may include one or more antennas and related components to enable the user device 202 to communicate via wireless protocols such as Wi-Fi, Bluetooth, NFC, and other such protocols. The AOP 208 may be a component of the wireless circuitry 206 or may be a separate component. The AOP 208 may be a processor configured to perform certain tasks of the user device 202 despite a state of the user device 202. For example, the AOP 208 may use less power than the application processor 212. The AOP 208 may perform background tasks associated with receiving and/or transmitting data via the wireless circuitry 206 while the user device 202 is not in an active state, allowing the application processor 212 to be in a low-power mode and saving battery power when the user device 202 is not in use.

In the example shown in FIG. 2, the buffer 210 may be a separate component of transitory or non-transitory computer memory (e.g., dynamic random access memory (DRAM), static random access memory (SRAM), solid-state memory, magnetoresistive random access memory (MRAM)), of any other suitable memory. In other examples, the buffer 210 may be a component of the application processor 212 and/or the AOP 208. The buffer 210 may be configured to store one or more packets of data received from one or more external devices, such as the external device 204.

The application processor 212 may be used to perform various tasks associated with the user device 202. The application processor 212 may perform tasks such as processing various data, rendering image files for display, executing applications (e.g., when the user device 202 is in an active state), etc. The application processor 212 may use more power than other processors within the user device 202, such as the AOP 208. Therefore, the application processor 212 may operate in two or more modes. For example, the user device 202 may be in a non-active state. A user of the user device 202 may have placed the user device 202 in the non-active state via an input and/or the user device 202 may have entered the non-active state after a period of non-use. Because the user device 202 is in the non-active state, the application processor 212 may be in a low-power mode. While in the low-power mode, the application processor 212 may perform limited tasks, such as operating system (OS) tasks and other background tasks. When the user device 202 enters the active state, the application processor 212 may enter a high-power state.

While in the high-power state, the application processor 212 may perform more resource-intensive tasks such as graphic display, audio playback, voice calls, etc.

### B. Process Using Buffer and Auxiliary Processor

At 203, the user device 202 may receive data 214 from the external device 204. The data 214 may be received by the user device 202 via the wireless circuitry 206. For example, the external device 204 may broadcast the data 214 via Bluetooth. The wireless circuitry 206 may receive the data 214 via an antenna tuned to send and receive Bluetooth signals. The user device 202 may be in the non-active state. The external device 204 may also be in a non-active state. For example, a lid of the external device 204 may be closed. Earbuds inside the lid of the external device 204 may not be playing audio while the lid of the external device is closed. In fact, the earbuds of the external device 204 may not be actively connected to the user device 202 at all. While in the non-active state, the external device 204 may broadcast the data 214 at a regular interval (e.g., 500 ms, 1 second, 2 seconds, etc.). As the external device 204 is not connected to the user device 202, the data 214 may be widely broadcast (as opposed to transmitted solely to the user device 202). The data 214 may include information such as a packet type, a device ID, a status of the external device 204, and/or other information.

At 205, the AOP 208 may preprocess some or all of the data 214. During the preprocessing, the AOP 208 may determine the packet type of the data 214, the device ID of the sender of the data 214 (i.e., the external device 204), a received signal strength indicator (RSSI), and other such information. In some embodiments, the AOP 208 (and/or other components of the user device 202) may be configured to only store data of a certain packet type during the process 201. If the data 214 is of the certain packet type (e.g., type 7), the data 214 may continue to be preprocessed and/or stored. If the data 214 is of another packet type, the data 214 may be discarded. By only maintaining data of the certain packet type, the AOP 208 may use even less power, as only relevant packets of data may be processed (or preprocessed). In other embodiments, the AOP 208 may preprocess and/or store data of multiple types. In some embodiments, the AOP 208 may utilize the RSSI to determine a proximity of the external device 204 to the user device 202.

At 207, the AOP 208 may cause some or all of the data 214 to be stored in the buffer 210. The AOP 208 may store the data 214 in the buffer 210 based at least in part on the preprocessing done at 205. For example, the AOP 208 may determine that the data 214 is of the certain packet type. The AOP 208 may then determine that the proximity of the external device 204 is within a proximity threshold (e.g., less than or equal to 1 m, less than or equal to 2 m, etc.). Then, the AOP 208 may cause the data 214 to be stored in the buffer 210. If, by contrast, the data 214 was of a different packet type and/or outside the proximity threshold, the AOP 208 may cause the data 214 to be discarded.

At 209, the user device 202 may receive a trigger 216. The trigger 216 may be a user input causing the user device 202 to enter an active state. The trigger 216 may additionally or alternatively correspond to an input at the external device 204. For example, the user may cause the user device 202 to enter the active state and open the lid of the case of the external device 204. Because the user device 202 and the external device 204 may be in an active state (or have a lid open), the application processor may determine that a status of the external device 204 should be displayed.

In some embodiments, the AOP 208 generates the trigger in response to some or all of the data 214. For example, the data 214 may be of a particular packet type, associated with a specific device ID. The particular packet type may indicate a device that can be attached to various objects, such as car keys. The specific device ID may indicate a high-priority device (e.g., the user indicated that the high-priority device is attached to car keys). Then, the AOP 208 may determine that the high-priority device is within the proximity threshold and generate a trigger. One of ordinary skill in the art would recognize many different possibilities.

At 211, the application processor 212 may access the data 214 from the buffer 210 and process the data 214. The application processor 212 may determine a status of the external device 204 from the data 214, determine the proximity of the external device 204, and/or determine other information about the external device 204. Additionally or alternatively, the application processor 212 may determine a pairing status of the external device 204.

Then, at 213, the application processor 212 may use information determined at step 211 to generate a notification 218. For example, the external device 204 may be new to the user device 202 (e.g., never having been connected). Thus, the application processor 212 may determine that the external device 204 has not been connected and generate a pairing request as the notification 218. Alternatively, if the external device 204 has previously been paired with the user device 202, the application processor 212 may cause the user device 202 to connect to the external device 204 and generate a status notification as the notification 218.

At 215, the user device 202 may cause the notification 218 to be displayed. The notification 218 may include elements to accept a user input. If the notification 218 is a pair request, for example, the notification 218 may include an element allowing a user to prompt the user device 202 to pair with the external device 204.

Although the system 200 and process 201 show and describe a single packet of data (i.e., the data 214), it should be understood that the external device 204 may broadcast any number of packets of data. The external device 204 may broadcast data at regular intervals. The user device 202 may receive each data packet and perform at least the steps 203-207. The buffer 210 may therefore include multiple data packets similar to the data 214, received from the external device 204 over some period of time. In some embodiments, the buffer 210 may store a particular number of data packets (e.g., 50, 100, 150, etc.). Additionally or alternatively, the buffer 210 may store data packets for a period of time (e.g., 10 min., 15 min., 1 hour, etc.). Upon receiving the trigger 216, the application processor 212 may only access the most recent data packet.

Additionally or alternatively, the external device 204 may continue broadcasting data after the trigger 216. For example, after the lid of the external device 204 is opened, other data may be broadcast and/or transmitted directly to the user device 202. The other data may include information associated with the external device 204 such as an indication that the lid is open (potentially indicating that the external device is in an active state), a current power level, and other such information. The user device 202 may utilize some or all of the other data (in conjunction with the data 214) to generate and display the notification 218.

### III. Determining Data to be Stored and Processed

While the example shown and described in FIG. 2 illustrates a single external device broadcasting data, there may be multiple external devices broadcasting data, or “advertisements.” Each advertisement may include a data type, where the data type is correlated with a device type. Storing and processing all advertisements from all devices may be resource-intensive, using processor power and/or memory to process unnecessary advertisements. Thus, the user device may only store and process certain advertisements, deleting other advertisements. To determine which advertisements to store and process, the user device may utilize one or more characteristics of the advertisements, including a data type, a proximity, a device ID, and/or other characteristics.

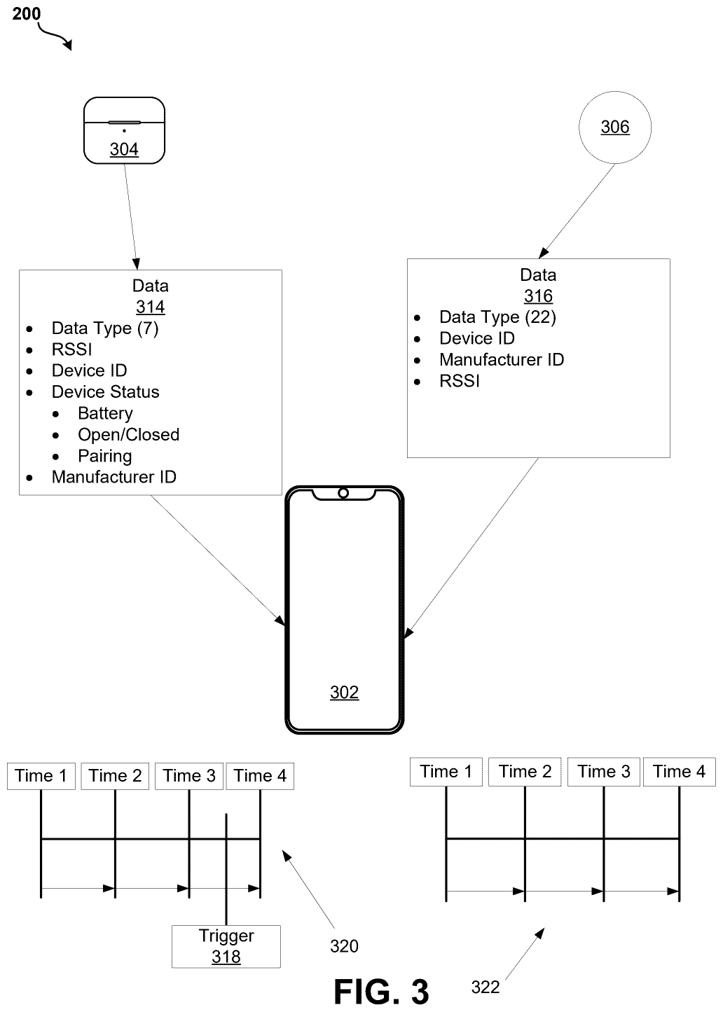

FIG. 3 illustrates an external device 304 broadcasting data 314, according to certain embodiments. The external device 304 may be a peripheral device, such as headphones, a video display, a mouse, a keyboard, or any other suitable type of device. In the example shown in FIG. 3, the external device 304 may be earbuds within a case. The data 314 may be a first advertisement, broadcast at an interval 320. The data 314 may include characteristics such as a data type, a device ID, a device status, a manufacturer ID, an RSSI, and/or other information. A second external device 306 may broadcast data 316. The data 316 may be a second advertisement. The second external device 306 may broadcast the data 316 at an interval 322. The interval 322 may be the same as interval 320, or may be a different interval. The data 316 may include the same information as the data 314 or may include different information. As shown in FIG. 3, the data 316 may include a data type, a device ID, a manufacturer ID, an RSSI, and/or other information.

The external device 304 may be an active device (e.g., earbuds in a case). An active device may mean an external device that is paired with a user device 302 and transmits data to and from the external device and the user device 302. While the external device 304 is in an inactive state (e.g., the lid of the case is closed), the external device 304 may transmit the data 314 according to the interval 320. As shown in FIG. 3, the device status indicated in the data 314 may include an “open/closed” indication. At time 1, time 2, and time 3, the lid may be closed and the data 314 may indicate the same. Between times 3 and 4, however, the user may open the lid resulting in a trigger 318. In response to the trigger 318, the external device 304 may transmit the data 314 before the next scheduled interval (i.e., time 4). The data 314 may then indicate an “open” status.

The user device 302 may determine that the data 314 should be stored and processed (e.g., as outlined in relation to FIG. 1) based on the characteristics of the data. For example, at times 1-3, the user device 302 may utilize the RSSI to determine a proximity of the external device 304 to the user device 302. The user device 302 may then determine that the external device 304 is within a proximity threshold (e.g., 1 m, 2 m, 3 m, etc.). In response to determining that the external device 304 is within the proximity threshold, the user device 302 may use other characteristics to determine whether or not to store and process the data 314.

Accordingly, the user device 302 may determine that the data 314 is of data type 7. Data type 7 may indicate that the external device 304 is earbuds, an active device that may be connected to the user device 302 to perform some function (here, audio playback). The user device 302 may additionally or alternatively determine that the manufacturer ID and/or the device ID indicated in the data 314 corresponds to a known device, or a device likely to be connected to the user device 302. For instance, the manufacturer ID may indicate that the external device 304 is manufactured by the same company as the user device 302. The user device 302 may then determine that the external device 304 may likely be paired with the user device 302 at some point. Similarly, the user device 302 may determine that the external device 304 has previously been paired with the used device by comparing device ID indicated in the data 314 with known device IDs.

Based at least in part on the characteristics of the data 314, the user device 302 may determine that the data 314 should be stored and processed. At the trigger 318, the user device 302 may then use the stored data 314 (and/or data broadcast as a result of the trigger 318) to generate a notification (e.g., the notification 218 in FIG. 2).

By contrast, the second external device 306 may be a passive device, such as a wireless tag. The wireless tag may be attached to an object (e.g., car keys) of interest to a user of a user device 302 (e.g., the user device 302). The user device 302 (or a user thereof) may not be interested in the data 316 until the user device 302 is in an active state (e.g., a user is trying to locate the object attached to the wireless tag). The user device 302 may first determine the data type indicated in the data 316. In the example shown in FIG. 3, the data type may be 22. The user device 302 may only store and process data of type 7, however, and the data 316 may be discarded.

In some embodiments, the user device 302 may utilize the other characteristics to determine whether or not to store and process the data 316. For example, the user device 302 may determine that data of type 22 should be stored and processed if the associated device is within the proximity threshold. Upon receiving the data 316, the user device 302 may determine that the data 316 is of the data type 22, then determine a proximity using the RSSI. If the proximity is within the proximity threshold, the data 316 may be stored and processed. One of ordinary skill in the art would recognize many different possibilities. By only keeping data of certain data types and/or having other characteristics (e.g., within the proximity threshold, a device ID, etc.), the user device 302 may more efficiently store and process data. Upon entering the active state, the user device 302 may therefore only process data relevant to user.

### IV. Generating Notifications Based on Advertisements

One advantage of the systems and methods described herein may be the decreased latency between triggering an external device (e.g., opening the lid of earbuds) and a notification being displayed on the user device. Some or all of these methods and processes may be performed by an application processor, but doing so may use significant amounts of battery power, trading lower latency for decreased battery life. If, however, some or all of the preprocessing may be performed by an auxiliary processor, lower latency may be achieved while using less battery power.

### A. Receiving and Preprocessing Data With an Auxiliary Processor

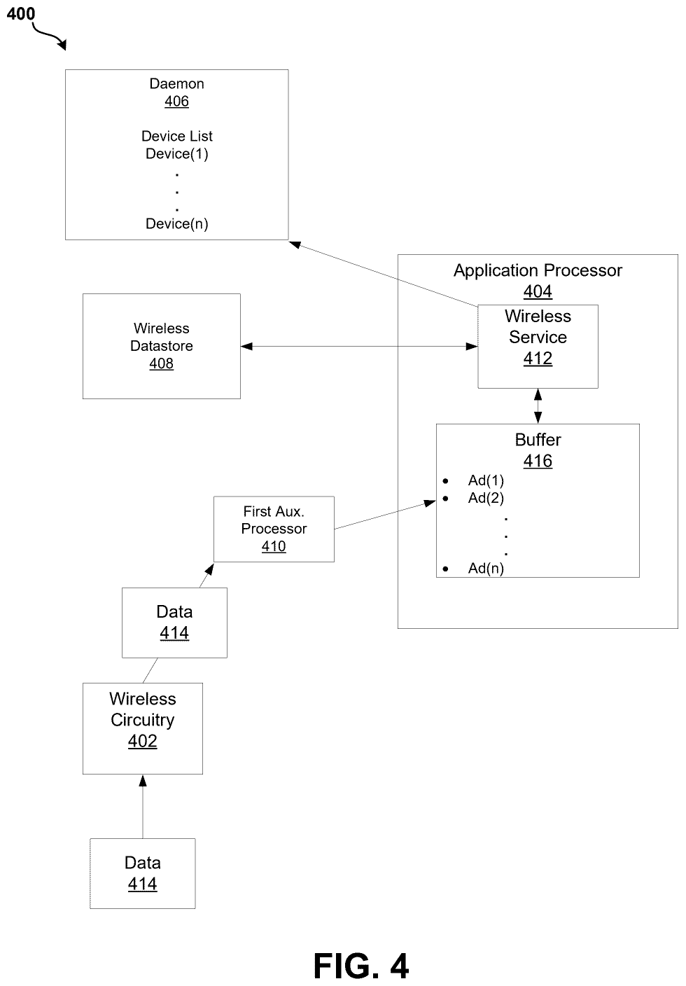

FIG. 4 illustrates a system 400 for receiving and preprocessing data with a single auxiliary processor, according to certain embodiments. The system 400 may be included in a user device, such as the user device 302 in FIG. 3. The system 400 may include wireless circuitry 402, an application processor 404, a daemon 406, a wireless datastore 408, and an auxiliary processor 410. The wireless circuitry 402 may include one or more antennas and other components configured to transmit and receive wireless signals via various communications standards. The various communications standards may include Bluetooth, Wi-Fi, Wi-Fi Direct, NFC, Zigbee, Z-wave, and/or any other suitable technology. The wireless circuitry 402 may be at least partially operable when the user device is not in an active state. For example, the wireless circuitry 402 may receive data 414 and/or other data while the user device is in a power saving mode (e.g., a display of the user device is off). The data 414 may be an advertisement from an external device, such as the data 314 in FIG. 3. Thus, the data 414 may include one or more characteristics such as a data type, an RSSI, a device ID, a manufacturer ID, a device status, etc.

The auxiliary processor 410 may be a processor configured to perform low-level operations for one or more components of the user device. The auxiliary processor 410 may utilize less power than the application processor 404, allowing some functions to be performed by the user device even when the user device is not in an active mode. For example, the auxiliary processor 410 may control some functions of receiving data via the wireless circuitry 402, such as parsing data included in incoming advertisements (e.g., the data 414).

The application processor 404 may be a processor configured to perform one or more operations according to instructions stored on a memory of the user device (or otherwise received by the user device). The application processor 404 may include one or more power modes. For example, when the user device is in an active state, the application processor 404 may be in a high power mode. The high power mode may enable the application processor 404 to perform power-intensive tasks such as graphics rendering, data processing, device pairing, audio playback, and other such tasks. Put differently, the application processor 404 may be in a high power mode when the user device is actively performing operations for a user. By contrast, the application processor 404 may enter a low power mode while the user device is not in use. The application processor 404 may perform background tasks or other low power tasks, but not tasks like device pairing etc.

The application processor 404 may also include (or access) a wireless service 412. The wireless service 412 may be configured to enable communication between external devices and the application processor 404 (and/or applications executed on the user device. The wireless service 412 may perform functions to enable wireless communications, including initialization of a connection, data routing, device identification, and/or other functions.

The daemon 406 may be a background application executed on the user device. The daemon 406 may include a device list indicating one or more devices associated with data received by the wireless circuitry 402. For example, in relation to FIG. 3, the wireless circuitry 402 may have received the data 314 from the external device 304 and the data 316 from the second external device 306. The daemon 406 may therefore indicate the external device 304 and the second external device 306 in the device list. In some embodiments, the device list may only include known external devices (e.g., external devices that have been previously paired with the user device). In other embodiments, the device list may include a list of all external devices from which data has been received. In some embodiments, the daemon 406 may include other characteristics of received data (e.g., RSSI, statuses, etc.). The data included in the daemon 406 may be persistent or may be maintained for a given time period.

The wireless datastore 408 may include information associated with paired external devices. For each paired device, the information may include a device ID, user preferences/settings (e.g., default volume, performance settings, brightness settings, etc.), and/or other such information. The information may be accessible by the application processor 404 and accessed to perform operations such as device identification as part of a pairing process. The wireless datastore 408 may be accessed by the application processor 404 via a system peripheral interface (SPI), controller area network (CAN) bus, and/or any other appropriate connection.

The data 414 may be received by the wireless circuitry 402. The data 414 may then be transmitted to the auxiliary processor 410 via a system power management interface (SPMI). Then, the auxiliary processor 410 may determine one or more characteristics of the data 414. For example, the auxiliary processor 410 may first determine a data type indicated in the data 414 (e.g., type 7 as described in FIG. 3). The auxiliary processor 410 may also determine characteristics such as a proximity (based on an RSSI indicated in the data 414), a device ID, a manufacturer ID, and other such characteristics.

Based on the one or more characteristics, the auxiliary processor 410 may cause some or all of the data 414 to be stored in a buffer 416. The buffer 416 may be included in the application processor 404 or may be a separate component, accessible by the application processor 404. For example, the buffer 416 may be a physical and/or logical segment of a transitory or non-transitory memory, included in the user device. The buffer 416 may be a circular buffer. The buffer 416 may include one or more advertisements (e.g., the data 414) received while the application processor is in a low power mode. The one or more advertisements may be from the same external device or from different external devices. The buffer 416 may store any number of advertisements (ad(1)-ad(n)). If the one or more advertisements are from the same external device, the buffer 416 may include a list of those advertisements received in some time period (e.g., the previous 1 minute, the previous 2 minutes, the previous 10 minutes, etc.). Additionally or alternatively, the buffer 416 may include a given number of advertisements for the external device, such as the most recent 5 advertisements, the most recent 10 advertisements, etc. Thus, an amount of data (i.e., advertisements) stored in the buffer 416 may be limited, allowing for more efficient use of memory resources.

The application processor 404 may subsequently enter a high power mode (e.g., the user device is in an active state). Then, the application processor 404 may cause the wireless service 412 to access the advertisements (e.g., the data 414) stored in the buffer 416. In some embodiments, the wireless service 412 may determine that the data 414 indicates a proximity within the proximity threshold (e.g., 1 m). Then, the wireless service 412 may determine a device ID indicated in the data 414. The wireless service 412 may then access the wireless datastore 408 via the SPI to determine a pairing status, user settings, and other information. For example, the wireless service 412 may access the wireless datastore 408 and determine that the external device associated with the data 414 is a known device. Then the wireless service 412 may determine a device status of the external device from the data 414 and/or from data received subsequently (e.g., after the lid of the external device is opened). The wireless service 412 may then cause a notification to be generated indicating the device status, device name, etc.

### B. Displaying Notifications

After determining the one or more characteristics of the data (or advertisement), the user device may generate notifications for display by the user device. For a known external device, the notification may include a device status, etc. Other notifications may also be generated, however.

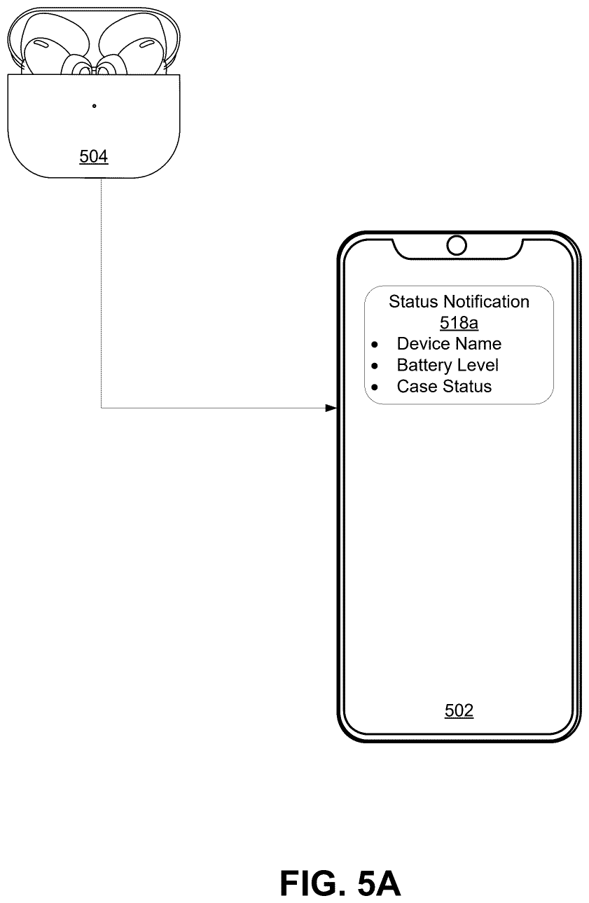

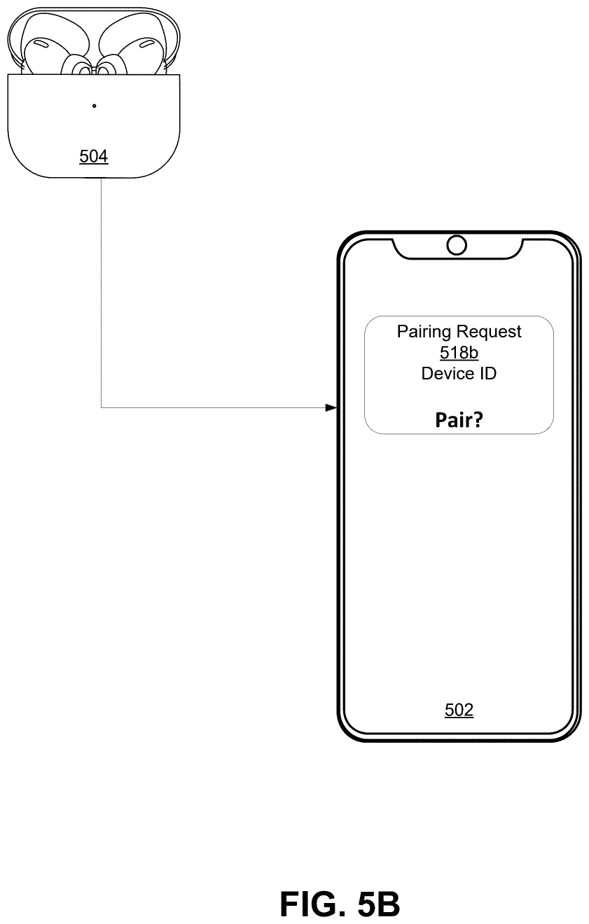

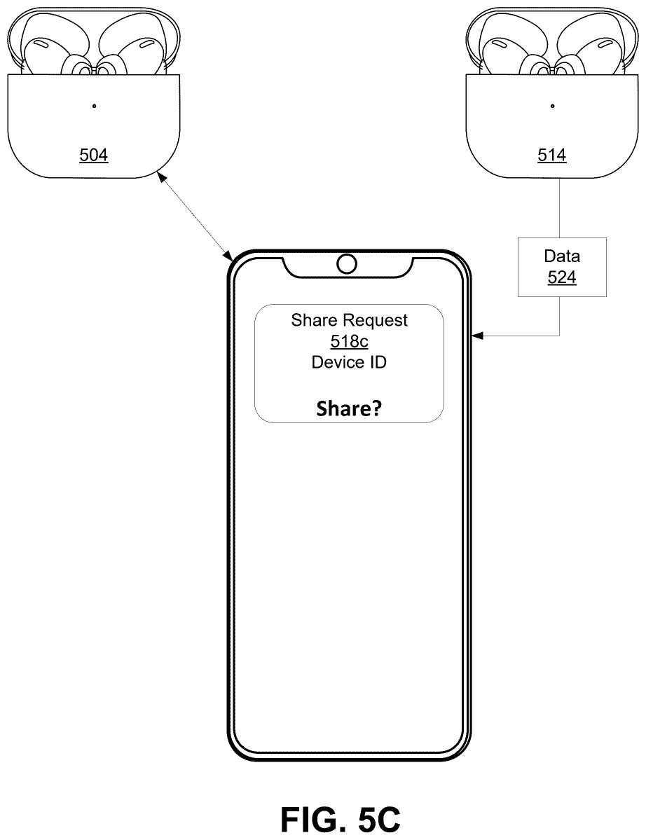

FIG. 5A illustrates a user device 502 displaying a status notification 518a, according to certain embodiments. The user device 502 may be similar to the user device 202 in FIG. 2. The user device 502 may also include components similar to those described in FIG. 4, such as wireless circuitry, an auxiliary processor, an application processor, a wireless service etc. An external device 504 may be similar to the external device 204 described in FIG. 2. As shown in FIG. 5A, the external device 504 may be earbuds in a case. Although the external device 504 is shown as earbuds, it should be understood that the external device 504 may be any type of external device. In contrast to the external device 204, the lid of the case of the external device 504 may be open, such that a user may begin using the external device 504. As such, the user may want to know various information about the external device, such as a battery level, volume setting, and/or other information. Thus, the user device 502 may cause the status notification 518a to be displayed.

Prior to the lid of the case of the external device 504 being opened, the external device 504 may broadcast advertisements at some predetermined interval. The advertisements may be similar to the data 414 and include one or more characteristics about the external device. The one or more characteristics may include a device ID, a data type, a manufacturer ID, a device status, and/or other information. The user device 502 may receive the advertisement and store and preprocess the advertisement as described in relation to FIG. 4. If the advertisement (or a number of advertisements) indicates that the external device 504 is within a proximity threshold of the user device 502, the user device 502 may further process the advertisement when the user device 502 is in an active state.

In the example shown in FIG. 5A, the user device 502 may determine that the external device 504 is a known device (e.g., the external device 504 has been previously paired to the user device 502). Then, based at least in part on data stored in a buffer of the user device 502, the user device 502 may generate the status notification 518a. The status notification 518a may include information such as a device name (of the external device 504), a battery level of the external device 504, and other such information. The status notification 518a may additionally or alternatively provide inputs to change various user settings, such as equalizer settings, volume, user profiles, etc.

FIG. 5B illustrates the user device 502 displaying a pair request 518b, according to certain embodiments. In the example shown in FIG. 5B, the user device 502 may determine that the external device 504 is an unknown device (e.g., has not been previously paired to the user device 502). Then, the user device may cause pairing request 518b to be generated. The pairing request 518b may include information such as the device ID of the external device 504, a battery level of the external device 504, and other such information. The pairing request 518b may include a link or button configured to accept a user input. In accordance with the user input, the user device 502 may then pair with the external device 504.

FIG. 5C illustrates the user device 502 displaying a share request associated with a second external device 514, according to certain embodiments. The user device 502 may be paired with the external device 504. The user device 502 may be providing audio playback operations via the external device 504. During the playback operations, the second external device 514 may broadcast data 524 (e.g., an advertisement). The data 524 may include one or more characteristics such as a data type, an RSSI, a device ID, a manufacturer ID, a device status, etc. The user device 502 may determine that the second external device 514 is an unknown device (e.g., based on the device ID of the second external device 514). Then, the user device 502 may determine that the second external device 514 is within a second proximity threshold. The second proximity threshold may be identical to the proximity threshold or may be different. The proximity threshold for a known device (e.g., the external device 504) may be 1 m. This means that if the external device 504 is within 1 m, a status notification and/or automatic pairing may be performed upon the user device 502 entering the active state. The second proximity threshold, however, may be shorter (e.g., 5 cm, 10 cm, etc.).

The shorter distance of the second proximity threshold for unknown devices may allow notifications to be generated only for those external devices that are likely to be paired with the user device. For example, in an airplane or similar environment, any number of unknown external devices may be within the proximity threshold of the user device 502. If, however, the second external device 514 is brought within the shorter second proximity threshold (e.g., 5 cm), the user device 502 may determine that the user may wish to share the audio playback with the second external device 514. Then, the user device 502 may generate the share request 518c. The share request 518c may include information such as the device ID of the second external device 514, a battery level of the external device 514, and other such information. The share request 518c may include a link or button configured to accept a user input. In accordance with the user input, the user device 502 may then pair with the second external device 514.

### V. Method for Displaying Status Notifications

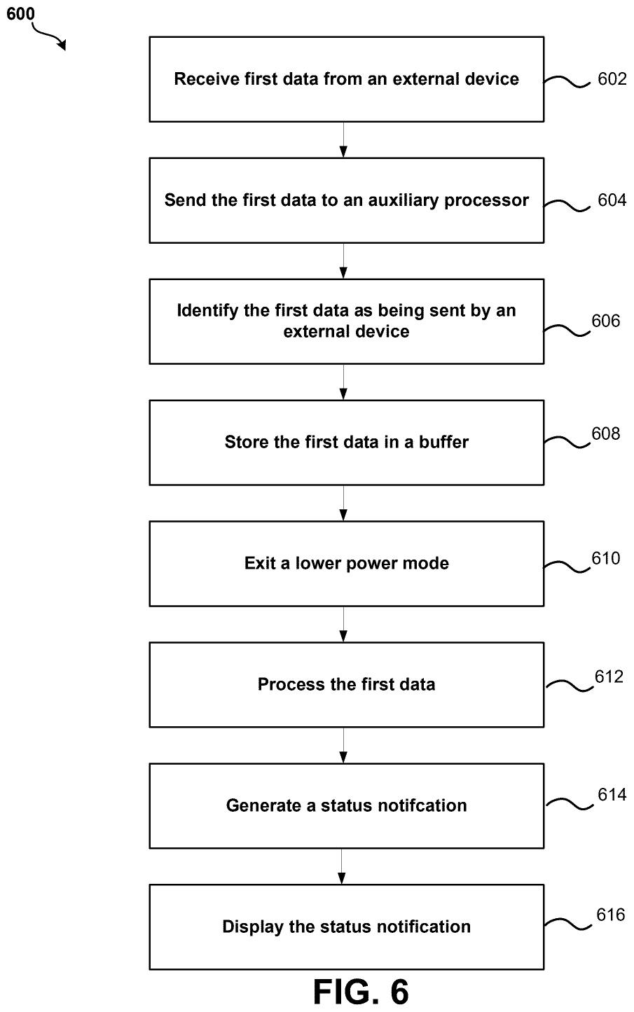

FIG. 6 illustrates a method 600 for displaying status notifications, according to certain embodiments. The method 600 may be performed by some or all of the systems and devices described herein, such as the systems 100-400 in FIGS. 1-4. Some steps of the method 600 may be performed in a different order than is shown and described and/or combined with other steps. In some embodiments, some steps may be skipped altogether.

At 602, the method 600 may include receiving, by wireless circuitry of an electronic device, first data from an external device. The electronic device may be a user device, such as the user device 102 in FIG. 1. The external device may be similar to the external device 204 in FIG. 2. The first data may be an advertisement, broadcast by the external device at regular intervals. The first data may include information identifying the external device and a status of the external device. For example, the information may include a data type (e.g., type 7), a device ID, a device status, a manufacturer ID, an RSSI, and/or other information. The first data may be received while an application processor of the electronic device is in a lower power mode. For example, the electronic device may be in an inactive state (e.g., a display of the electronic device is off). The application processor may therefore be in the lower power mode in order to extend a battery life of the electronic device.

At 604, the method 600 may include transmitting, by the wireless circuitry, the first data to an auxiliary processor. The auxiliary processor may be similar to the auxiliary processor 410 in FIG. 4. The auxiliary processor may be powered on more often than the application processor. The auxiliary processor may be configured to perform low-level operations for one or more components of the electronic device. For example, the auxiliary processor may control some functions of receiving data via the wireless circuitry, such as parsing data included in incoming advertisements (e.g., the data 414).

At 606, the method 600 may include identifying, by the auxiliary processor of the electronic device, the first data as being received from the external device. For example, the first data may indicate a device ID associated with the external device. The electronic device may then utilize the device ID to determine that the external device is a known device (e.g., by accessing a wireless datastore as described in FIG. 4).

Responsive to identifying the first data as received from the external device, at 608, the method 600 may include storing the first data in a buffer for subsequent access by the application processor. In some embodiments, the first data may be stored based on a data type indicated in the first data. For example, the electronic device may be configured to only store advertisements of a certain type and/or from certain devices (e.g., type 7, broadcast by earbuds). The auxiliary processor may then determine that the first data is of type 7 and broadcast by earbuds and cause the first data to be stored in the buffer. If, by contrast, the first data indicated a different data type (e.g., type 18), the first data may be discarded. Additionally or alternatively, the user device may be configured to only store the first data if the external device is within a proximity threshold (e.g., as determined by an RSSI indicated in the first data).

In response to receiving a trigger, at 610, the method 600 may include exiting the lower power mode for the application processor. The trigger may include a user input at the electronic device and/or the external device. For example, the trigger may be generated by a user pressing a button on the electronic device, causing the electronic device to enter an active state. The trigger may also include a lid being opened at the external device. Exiting the lower power mode may cause the application processor to enter a higher power mode. While in the higher power mode, the application processor may perform more resource-intensive tasks (e.g., operating the wireless service 412 in FIG. 4).

At 612, the method 600 may include processing, by the application processor, the first data from the buffer to determine the status of the external device. For example, the application processor may use some or all of the first data to determine whether the external device is a known device or not. The application processor may also determine a battery level of the external device, user settings associated with the external device, and other such information. In some embodiments, the application processor may use other data, received after the trigger and after the first data.

At 614, the method 600 may include generating, by the application processor, a status notification based on the status of the external device. For example, the electronic device may determine that the external device is a known device (e.g., the external device has been previously paired to the user device). Then, based at least in part on data stored in the buffer of the user device, the electronic device may generate the status notification. The status notification may include information such as a device name, a battery level of the external device, and other such information. The status notification may additionally or alternatively provide inputs to change various user settings, such as equalizer settings, volume, user profiles, etc.

In another example, the electronic device may determine that the external device is an unknown device (e.g., has not been previously paired to the user device). Then, the electronic device may cause a pairing request to be generated. The pairing request may include information such as the device ID of the external device, a battery level of the external device, and other such information. The pairing request may include a link or button configured to accept a user input. In accordance with the user input, the electronic device may then pair with the external device.

At 616, the method 600 may include displaying the status notification. The status notification may be displayed by the electronic device or may be displayed on a connected display. The status notification may include a status, a pairing request, and/or a sharing request.

In some embodiments, the method 600 may include after exiting the low power mode receiving, by the wireless circuitry, second data from a second external device (e.g., the second external device. The second data may identify the second external device. The method 600 may include determining, by the wireless circuitry, that the second external device is not paired with the electronic device. The method 600 may include generating, by the application processor, a share request. In response to a user input corresponding to the share request, the electronic device may pair with the second external device. The method 600 may also include displaying the share request.

In some embodiments, the method 600 may include determining, by the application processor, a signal strength associated with the external device based at least in part on the data received from the external device (e.g., RSSI data). The method 600 may include determining, by the application processor, whether or not the external device is within a proximity threshold of the electronic device based at least in part on the signal strength. The proximity threshold may be about 0.5 m, about 1 m, about 1.5 m, etc.). In response to determining that the external device is outside of the proximity threshold, the method 600 may include causing the data to be deleted from the buffer. In response to determining that the external device is within the proximity threshold, the method 600 may include generating, by the application processor, the status notification.

In some embodiments, the method 5600 may include determining, by the auxiliary processor, a signal strength associated with the external device based at least in part on the data received from the external device (e.g., using RSSI data). The method 600 may include determining, by the auxiliary processor, whether the external device is within a certain proximity of the electronic device, based at least in part on the signal strength. The method 600 may also include generating, by the auxiliary processor, the trigger. In other words, the trigger may be in response to an advertisement of a certain type, received from a certain distance from the electronic device.

In some embodiments, the method 600 may include determining, by the auxiliary processor, positioning data from a global positioning module of the electronic device. The method 600 may also include storing the positioning data in the buffer, such that the positioning data is associated with the first data.

### VI. Example Auxiliary Processor Architecture

As described herein, the ability to collect location data (or information) and generate accurate locations can provide benefits and services to the users. However, a large amount of historical location data may need to be stored while the mobile device is in a low-power state (e.g., sleep mode).

An auxiliary processor architecture can utilize a certain part of storage space (e.g., cache memory of a main processor and referred to herein as cache) of a mobile device that is not being used while the main processor (e.g., application processor (AP)) is in a low-power mode (e.g., a sleep mode) to store historical location data. After the AP wakes up (i.e., exits the sleep mode), the stored historical location data can be moved from the cache memory (e.g., static random-access memory (SRAM)) to larger system memory (e.g., dynamic random-access memory (DRAM)), where the AP can access and process the stored historical location data while performing its normal function to use its cache memory. The auxiliary processor (e.g., an always-on processor) is powered on more often than the application processor.

### A. System Components

The always-on system architecture may include one or more processors and various components (e.g., sensors, storage, interfaces, etc.) to provide the always-on functionality and experience to a user of a mobile device. The architecture may be implemented on a system-on-chip (SoC) or a circuit board to tightly integrate the components.

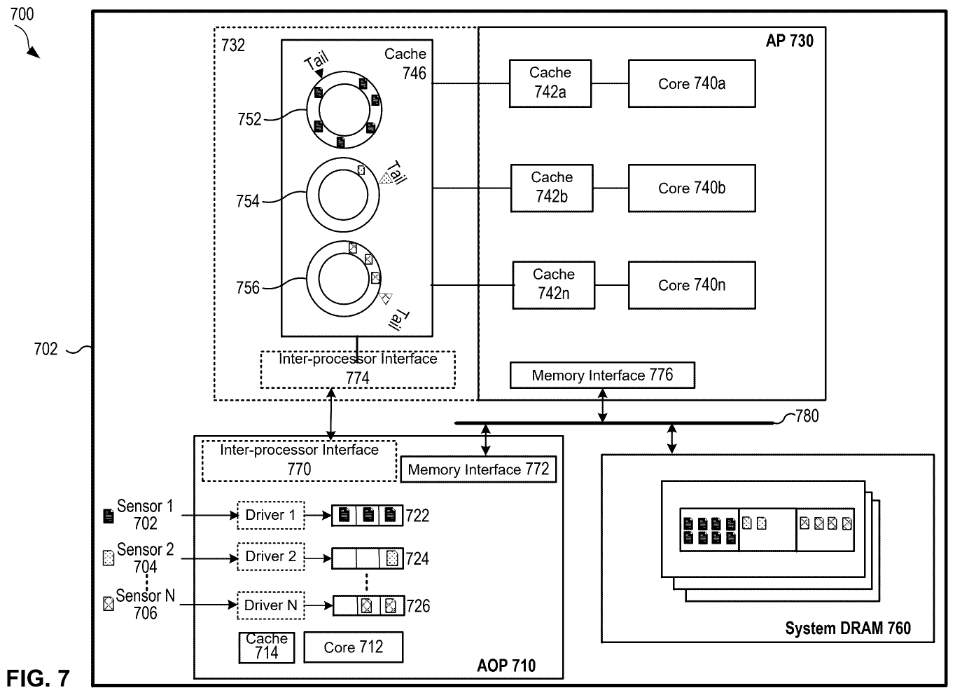

FIG. 7 is a block diagram of an example always-on system architecture 700, which may include a system-on-chip (SoC) 702 in a mobile device. In some embodiments, 702 may be a circuit board. The architecture 700 may be a multiprocessor system. SoC 702 may include an always-on processor (AOP) 710, an application processor (AP) 730, system memory (e.g., DRAM) 760, and cache memory 746 (referred to as cache) in a module 732 that may or may not be part of AP 730.

It should be apparent that the architecture 700 shown in FIG. 7 is only one example, and that SoC 702 can have more or fewer components than shown, or a different configuration of components. The various components shown in FIG. 7 can be implemented in hardware, software, or a combination of both hardware and software, including one or more signal processing and/or application specific integrated circuits. In some embodiments, AOP 710 and AP 730 may be different integrated circuits (ICs referred to as chips) on a circuit board.

In FIG. 7, AOP 710 may be a small, low-power auxiliary processor that is always active for interacting with sensors, handling background operations, and waking up the operating system running on AP 730. Sensor measurements related to locations are referred to herein as location data. AOP 710 may have one or more processor cores 712 and local cache 714. One or more small buffers (e.g., 722, 724, and 726) can be used to temporarily store location data from various sensors (e.g., sensor 1 702, sensor 2 704, and sensor N 706), one buffer per sensor (e.g., buffer 722 for sensor 1 702, buffer 724 for sensor 2 704, and buffer 726 for sensor N 706). In some embodiments, a shared buffer space may be used to store data for all sensors. AOP may also include, but is not limited to, an inter-processor interface 770 for communicating with another processor (e.g., AP 730) and a memory interface 772 for accessing system DRAM 760.

The sensors 702-706 may be different location technologies, such as wireless fidelity (Wi-Fi), Bluetooth (BT), Bluetooth Low Energy or BLE, Global Positioning System (GPS), ultrawideband (UWB), etc. The raw location data from the sensors may be processed by their respective drivers before being placed into a buffer for each sensor.

AP 730 may be the main processor on a mobile device (e.g., phone or wearable watch) for processing data and performing user-facing tasks. The AP 730 may be a single or multicore processor (e.g., cores 740a-740n). Each core may have a small local cache (e.g., layer-1 (L1) cache) tightly integrated with the core. The AP 730 may also have one or more larger caches 746, such as layer-2 (L2) or layer-3 (L3) cache, that may or may not be integrated with the AP (i.e., on the same chip). The AP 730 may also include, but is not limited to, an inter-processor interface 740 for communicating with another processor (e.g., AOP 710) and a memory interface 772 for accessing system DRAM 760.

The cache 746 that can be accessed by both AOP 710 and AP 730 may be on the SoC 702. In some embodiments, the cache 746 (e.g., L2 or L3 cache for AP) may be integrated with and become part of AP 730. In that case, AOP 710 may communicate with and access the cache 746 through the inter-processor interface 770 of AOP 710 and the inter-processor interface 774 of AP 730. The inter-processor interfaces (770 and 774) may include various cache coherency mechanisms for maintaining cache coherence between AP 730 and AOP 710, as well as secured communication mechanisms. In other embodiments, the cache 746 may be separated from (or not integrated with) AP 730. As a result, AOP 710 may communicate with and access the cache 746 directly without using the inter-processor interfaces (770 and 774). In such case, cache coherency and secured communication mechanisms may be supported by other components (not shown) on the SoC 702.

A bus subsystem 780 may provide a mechanism for various components and subsystems to communicate with each other. For example, AOP 710 and AP 730 may access system memory 760 using their respective memory interfaces 772 and 776.

System memory 760 may provide temporary data storage for AP 730 to access and execute programs or applications. System memory 760 typically includes Dynamic Random-Access Memory (DRAM) in large quantity to store a large amount of data, and is shared among processors (e.g., AOP 710 and AP 730).

### B. System Operations and Data Flow

As discussed above, the always-on system architecture 700 may provide an all-day buffering capability to temporarily store location data from various sensors when the AP 730 is not active, such as in sleep mode. Once AP 730 wakes up and becomes active, the buffered location data can be processed. Since different parts of the storage space on the SoC 702 may be available when the AP 730 is asleep or awake, the temporarily stored location data may be moved depending on AP's status to make the best use of under-utilized resources and conserve power consumption.

For example, typically, processor cache memory may be implemented with static random-access memory (SRAM) in small quantities with faster access speed. The processor cache is available to use even when AP is asleep. On the other hand, system memory may be implemented in dynamic random-access memory (DRAM) in large quantities with slower access speed. DRAM may need to be constantly refreshed, and not available to use when AP is asleep to save power.

Because the cache 746 and the system DRAM 760 are available at different times, the AOP 710 may be configured to transfer or move the stored historical location data at the appropriate time.

As mentioned above, historical location data from sensors (702-706) may be temporarily stored in their corresponding buffers (722-726) in AOP 710. The data in each buffer may then be securely transferred to the cache 746 (through inter-processor interfaces 770 and 774 or not) when more data arrives. The storage space in the cache 746 may be organized into multiple circular buffers or queues (752-756), one for location data from each sensor, for example, circular buffer 752 for sensor 1 702, circular buffer 754 for sensor 2 704, and circular buffer 756 for sensor N 706. A circular buffer may hold a duration of location data (e.g., 15 minutes to an hour or more). Once the capacity of the circular buffer is reached, new data may overwrite the old data. Thus, each circular buffer may have an indicator (“tail”) indicating the start/end of its stored content. In some embodiments, the storage space in the cache 746 may not be partitioned but used for storing location data from all sensors by using an identifier for each sensor, for example, ID 1 for sensor 1's data 702, ID2 for sensor 2's data 724, etc.

When AP 730 wakes up, AOP 710 may move the stored historical location data in cache 746 to system DRAM 760 via memory interface 772 and bus subsystem 780 using a security protocol. The security protocol may ensure the data being transferred is tempered proof. The AP 730 can then access the historical location data from the system DRAM 760 via its memory interface 776 and bus subsystem 780. In some embodiments, the AP 730 can start accessing and processing the historical location data in the system DRAM 760 once the data is available and before the AOP 710 completes the data transfer. In other words, the cache 746 of the always-on system architecture 700 may act as a store-and-forward buffer.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

What is claimed is:

1. A method performed by an electronic device including wireless circuitry, an application processor, and an auxiliary processor, the method comprising:
receiving, by the wireless circuitry, first data from an external device, the first data comprising information identifying the external device and a status of the external device, wherein the first data is received while the application processor is in a lower power mode;
transmitting, by the wireless circuitry, the first data to the auxiliary processor, wherein the auxiliary processor is powered on more often than the application processor;
identifying, by the auxiliary processor of the electronic device, the first data as being received from the external device;
responsive to identifying the first data as received from the external device, storing the first data in a buffer for subsequent access by the application processor;
in response to receiving a trigger:
exiting, by the application processor, the lower power mode.;
processing, by the application processor, the first data from the buffer to determine the status of the external device;
generating, by the application processor, a status notification based on the status of the external device; and
displaying the status notification.

2. The method of claim 1, wherein the first data from the external device indicates a data type, and the electronic device stores the first data based on the data type.

3. The method of claim 1, wherein after exiting the low power mode for the application processor:
receiving, by the wireless circuitry, second data from a second external device, the second data comprising information identifying the second external device;
determining, by the wireless circuitry, that the second external device is not paired with the electronic device;
generating, by the application processor, a share request, wherein, in response to a user input corresponding to the share request, the electronic device may pair with the second external device; and
displaying the share request.

4. The method of claim 3, wherein the share request is generated based on a user input received by the external device.

5. The method of claim 1, the method further comprising:
determining, by the application processor, a signal strength associated with the external device based at least in part on the data received from the external device;
determining, by the application processor, whether or not the external device is within a proximity threshold of the electronic device based at least in part on the signal strength; and
in response to determining that the external device is outside of the proximity threshold, causing the data to be deleted from the buffer.

6. The method of claim 5, wherein, in response to determining that the external device is within the proximity threshold, the method further comprises generating, by the application processor, the status notification.

7. A computing device comprising:
wireless circuitry;
one or more processors comprising an auxiliary processors and an application processor; and
a memory storing instructions that, when executed by the one or more processors, cause the computing device to:
receive, by the wireless circuitry, first data from an external device, the first data comprising information identifying the external device and a status of the external device, wherein the first data is received while the application processor is in a lower power mode;
transmit, by the wireless circuitry, the first data to the auxiliary processor, wherein the auxiliary processor is powered on more often than the application processor;
identify, by the auxiliary processor, the first data as being received from the external device;
responsive to identifying the first data as received from the external device, storing the first data in a buffer for subsequent access by the application processor;
in response to receiving a trigger:
exit, by the application processor, the lower power mode.;
process, by the application processor, the first data from the buffer to determine the status of the external device;
generate, by the application processor, a status notification based on the status of the external device; and
display the status notification.

8. The computing device of claim 7, wherein in response to receiving the first data, the instructions further cause the computing device to:
determine, by the auxiliary processor, positioning data from a global positioning module of the computing device; and
store, by the auxiliary processor, the positioning data in the buffer such that the positioning data is associated with the first data.

9. The computing device of claim 7, wherein the external device comprises an audio playback device.

10. The computing device of claim 7, wherein the buffer comprises a circular buffer.

11. The computing device of claim 7, wherein the first data is included in a Bluetooth advertisement.

12. The computing device of claim 7, wherein only a portion of the data received by the wireless circuitry is stored in the buffer.

13. The computing device of claim 7, wherein the application processor generates a pairing request based on the data received from the external device.

14. The computing device of claim 7, wherein the buffer is configured to be accessible by the application processor while in a higher power mode.

15. A non-transitory computer-readable medium comprising instructions that, when executed by the one or more processors, causes the one or more processors to perform operations comprising:
receiving, by a wireless circuitry, first data from an external device, the first data comprising information identifying the external device and a status of the external device, wherein the first data is received while an application processor is in a lower power mode;
transmitting, by the wireless circuitry, the first data to an auxiliary processor, wherein the auxiliary processor is powered on more often than the application processor;
identifying, by the auxiliary processor, the first data as being received from the external device;
responsive to identifying the first data as received from the external device, storing the first data in a buffer for subsequent access by the application processor;
in response to receiving a trigger:
exiting, by the application processor, the lower power mode;
processing, by the application processor, the first data from the buffer to determine the status of the external device;
generating, by the application processor, a status notification based on the status of the external device; and
displaying the status notification.

16. The non-transitory computer-readable medium of claim 15, the operations further comprising:
determining, by the auxiliary processor, a signal strength associated with the external device based at least in part on the data received from the external device;
determining, by the auxiliary processor, whether the external device is within a certain proximity of the computing device, based at least in part on the signal strength; and
generating, by the auxiliary processor, the trigger.

17. The non-transitory computer-readable medium of claim 16, wherein determining whether the external device is within a certain proximity of the electronic device is based at least in part on location data of the computing device and/or movement data of the computing device.

18. The non-transitory computer-readable medium of claim 15, further comprising:
receiving, by the wireless circuitry, third data from the external device;
identifying, by the auxiliary processor of the computing device, the third data as being received from the external device, and being received at a later time than the first data;
storing the first data in a second memory and removing the first data from the buffer; and
storing the third data in the buffer for subsequent access by the application processor.

19. The non-transitory computer-readable medium of claim 15, wherein the buffer comprises a data associated with a plurality of external devices, the operations further comprising:
determining, by the application processor, a nearest external device of the plurality of external devices based at least on part with the data associated with the plurality of external devices; and
generating, by the application processor, the status notification based on the status of the nearest external device.

20. The non-transitory computer-readable medium of claim 15, wherein the external device comprises earbuds.
